(19) United States
(12) Patent Application Publication
(10) Pub. No.: US 2011/0078889 A1
(43) Pub. Date: Apr. 7, 2011

(54) FACIAL BLEMISH REMOVING DEVICE

(75) Inventor: Kevin M. Crucs, Copley, OH (US)

(73) Assignee: CRUCS HOLDINGS, LLC, Copley, OH (US)

(21) Appl. No.: 12/910,373

(22) Filed: Oct. 22, 2010

Related U.S. Application Data
(63) Continuation-in-part of application No. 12/108,715, filed on Apr. 24, 2008.

(51) Int. Cl. B23P 17/04; B23P 19/04

(52) U.S. Cl. 29/460; 29/428

(57) ABSTRACT

Methods of making a device for removing a facial blemish. A facial scraping element is configured to be substantially rigid and flat, and a distal end of the facial scraping element is transformed for contacting and advancing across a facial surface of a user. A pad member is configured to be substantially non-rigid and non-flat. The facial scraping element may be attached to the pad member to form a collection area between a surface of the pad member and a surface of the facial scraping element. The resultant device is capable of being gripped between a finger and thumb of a user and advanced across the face of a user to remove and collect facial blemishes.

This U.S. patent application claims priority to and is a continuation-in-part (CIP) of pending U.S. patent application Ser. No. 12/108,715, filed on Apr. 24, 2008, which is incorporated herein by reference in its entirety.

### TECHNICAL FIELD

Embodiments of the present invention relate to a device for removing facial blemishes. More particularly, certain embodiments of the present invention relate to methods for making a device for removing facial blemishes.

### BACKGROUND

The term “acne” is a general term to denote facial blemishes that are inflammatory disorders of the pilosebaceous unit. Acne is a group of disorders whose initial pathology is the comedo and includes acne vulgaris (common acne), neonatal acne, infantile acne, and pomade acne. Acne commonly afflicts adolescents and young adults, however, there is growing number of patients who develop acne in their late twenties or thirties. External agents that could exacerbate acne include medications e.g. iodides, anti-seizure, certain antibiotics and corticosteroids.

Acne is a chronic inflammatory disorder affecting the sebaceous glands. Acne lesions primarily involve the sebaceous glands located on the face, neck, chest and back. These lesions, including closed comedones (blackheads) and open comedones (whiteheads), are caused by hyperkeratinization of the infundibulum of the sebaceous duct. These keratinous plugs block the flow of sebum. These dilated ducts abound with the colonies of Propionibacterium acnes and other fat splitting organisms. The clinically evident open and closed comedones and the microscopic microcomedo are the signal lesions of acne. The acne process results from a cascade of events. First, at puberty a spike in androgen production heralds an increase in sebum production and begins the hyperkeratinization process causing microcomedones and sebum blockade. With this blockage, the number of resident follicular flora increases dramatically. These bacteria produce inflammatory products, which permeate through thin walls of dilated sebum-filled duct. Once in the perifollicular dermis, they trigger the body's own immune defenses (both acute and granulaomatous) to produce the characteristic inflammatory papules, pustules and nodules characteristic of inflammatory acne.

Increased sebum production; comedo formation, in which the follicular infundibulum hypercomifies, hyperkeratinizes, and hypodesquamates; colonization of the follicule by anaerobic Propionibacterium (mainly P. acnes); and the host's inflammatory response are generally believed to contribute to the development of acne. These four factors are interrelated. Sebum is comedogenic and causes inflammation by itself. The Propionibacterium has high lipolytic activity and liberates free fatty acids from sebum lipids, whereby the free fatty acids have been shown to cause marked inflammation. The microorganisms also produce other extracellular enzymes such as proteases and hyaluronidases, and chemotactic factors, which may be important in the inflammatory process.

Acne treatments generally target the keratinous plugs in sebaceous ducts; large sebaceous glands producing excess sebum, increased numbers of resident follicular bacteria, and inflammatory response to chemical mediators passing through the follicular wall. Most acne treatments are directed at preventing inflammatory lesions, particularly the larger nodulo-cystic lesions which tend to be destructive and lead to permanent scarring. In general, visible comedones are the only minor cosmetic nuisances and do not lead to inflammatory lesions.

Continued blockage of these follicle openings causes a rupture of the bacteria into the dermis which, in turn, provokes an inflammatory response that leads to the formation of pimples. It is thus desirable to remove the unwanted cell layer (i.e., blackheads) from obstructed follicle openings in order to reduce inflammation and thereby eliminate the pimples.

Acne pads have been known and marketed for several years. Typically, a number of circular acne pads are soaked in a cleansing solution and then applied topically to the acne. The cleansing solution is typically a bactericide such as benzoyl peroxide which removes the unwanted cell layer obstructing the follicle openings by killing the bacteria. Although effective in treating acne, the cleansing solution applied via the acne pads may result in substantial irritation of the skin. Further, acne pads are often insufficient to remove blackheads embedded in the dermis.

Indeed, removing blackheads embedded in the dermis often requires the application of force to the affected area. Typically, two fingernail tips are pressed at complementary angles on opposite sides of the blackhead to pinch the blackhead outwards from the dermis. Although effective in exposing the underlying follicle opening, using one's fingernail tips to remove blackheads may inadvertently and undesirably cut surrounding areas of the dermis. In addition, when using one's fingernail tips to remove blackheads, bacteria and other germs residing under one's fingernails may come into contact with the freshly exposed follicle openings and/or any cuts on the dermis resulting from the pinching action of the fingernail tips.

Notwithstanding the state of the art as described herein, there is a need for further improvements in devices and methods treating facial blemishes, including various forms of acne, that clean the pores of the skin without the introduction of any further infection.

### BRIEF SUMMARY

An embodiment of the present invention comprises a method of making a device for removing a facial blemish. A facial blemish may include whiteheads, blackheads, pimples, and acne, for example. The method includes configuring a substantially flat, elongated and rigid element having a top surface, a bottom surface, a distal end, and a proximal end. The method further includes configuring a substantially non-flat, three-dimensional, and non-rigid base member. The method also includes attaching the proximal end of the rigid element to the base member forming a facial blemish collection area between a first portion of a surface of the base member and the bottom surface of the rigid element such that the distal end of the rigid element extends away from the base member. The step of attaching may result in the rigid element being fixedly attached to the base member. Alternatively, the rigid element may be detachable from the base member. The steps of configuring and attaching result in a device that is capable of being gripped between a user's finger and thumb, where the finger rests on the top surface of the rigid element and the thumb rests on a second portion of the surface of the base member. Furthermore, the steps of configuring and attaching result in a device that is capable of being advanced across a face of the user when gripped, where at least the distal end of the rigid element and the first portion of the surface of the base member make contact with the face of the user as the device is advanced. Also, as the device is advanced, components of a facial blemish from at least one pore within a skin surface of the face are extracted and collected into the facial blemish collection area. The step of configuring the rigid element may result in the distal end of the rigid element being a narrow edge. The base member may have a substantially spherical shape or an ellipsoidal shape. The base member may be made of a porous material and an absorbent material. The method may further include adding a topical facial solution to the base member. The facial solution may include an anti-bacterial solution and a cleansing solution. The method may also include sealing the resultant device within a hermetically sealable package.

Another embodiment of the present invention comprises a method of making a device for removing a facial blemish. Again, a facial blemish may include whiteheads, blackheads, pimples, and acne, for example. The method includes configuring a substantially flat, elongated and rigid element having a top surface, a bottom surface, a distal end, and a proximal end. The method further includes configuring a substantially non-flat, three-dimensional, and non-rigid base member. The steps of configuring allow the rigid element to be attached to the base member to form a facial blemish collection area between a first portion of a surface of the base member and the bottom surface of the rigid element such that the distal end of the rigid element extends away from the base member. When attached, the rigid element and the base member form a device that is capable of being gripped between a user's finger and thumb, where the finger rests on the top surface of the rigid element and the thumb rests on a second portion of the surface of the base member. Also, when attached, the rigid element and the base member form a device that is capable of being advanced across a face of the user when gripped, where at least the distal end of the rigid element and the first portion of the surface of the base member make contact with the face of the user as the device is advanced. Furthermore, as the device is advanced, components of a facial blemish from at least one pore within a skin surface of the face are extracted and collected into the facial blemish collection area. The step of configuring the rigid element may result in the distal end of the rigid element being a narrow edge. The base member may have a substantially spherical shape or an ellipsoidal shape. The method may further include fixedly attaching the rigid element to the base member. Alternatively, the method may further include removably attaching the rigid element to the base member. The method may also include adding a topical facial solution to the base member. The method may further include sealing the rigid element and the base member within a hermetically sealable package.

A further embodiment of the present invention comprises a method of making a device for removing a facial blemish. The method includes configuring a facial scraping element to be substantially rigid and flat, having an upper surface and a lower surface, and further having a proximal end and a distal end. The method further includes transforming the distal end of the facial scraping element for contacting and advancing across a facial surface of a user. The method also includes configuring a pad member to be substantially non-rigid and non-flat. The method further includes attaching the proximal end of the facial scraping element to the pad member forming a collection area between a surface of the pad member and the lower surface of the facial scraping element such that the distal end of the facial scraping element extends away from the pad member. The step of transforming the distal end may include forming the distal end into a narrow edge capable of scraping a facial blemish off of a facial surface of the user when advanced across the facial surface. Alternatively, the step of transforming the distal end may include forming the distal end into a coarse surface capable of scraping a facial blemish off of a facial surface of the user when advanced across the facial surface. The pad member may include a coarse surface capable of loosening a facial blemish on a facial surface of the user when advanced across the facial surface. Alternatively, the pad member may include a non-coarse and absorbent surface.

These and other advantages and novel features, as well as details of an illustrated embodiment of the present invention, will be more fully understood from the following description and drawings.

### BRIEF DESCRIPTION OF THE DRAWINGS

FIG. 1 is a perspective view of an exemplary embodiment of a device for removing a facial blemish;

FIG. 2 is a bottom view of the device of FIG. 1;

FIG. 3 is a top view of another exemplary embodiment of a device for removing a facial blemish;

FIG. 4 is a bottom view of the device of FIG. 3;

FIG. 5 is a process diagram illustrating an exemplary embodiment of a method of use of the device of FIGS. 1-4 for removing a facial blemish;

FIG. 6 is a side profile view of a typical user holding and using the device of FIGS. 1-4 for removing a facial blemish;

FIG. 7 illustrates an embodiment of a method of making a device for removing a facial blemish; and

FIG. 8 illustrates a side view of yet another embodiment of a device, as made according to a method described herein, for removing a facial blemish.

### DETAILED DESCRIPTION

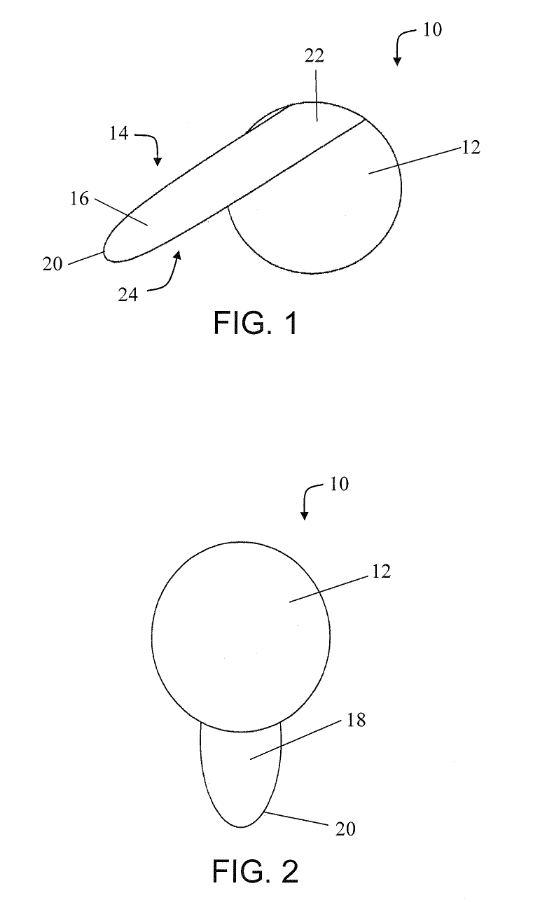

Referring now to the drawings wherein the showings are for purposes of illustrating certain embodiments of the present invention only and not for purposes of limiting the same, FIGS. 1-4 show a device 10 for removing a facial blemish. The device 10 includes a base member 12 and a rigid element 14 having a first top surface 16, a second bottom surface 18, a distal end 20 and a proximal end 22. The device 10 also includes a collection area 24 formed between a second or a bottom surface 18 of the distal end 20 of the rigid element 14 and a portion of the base member 12.

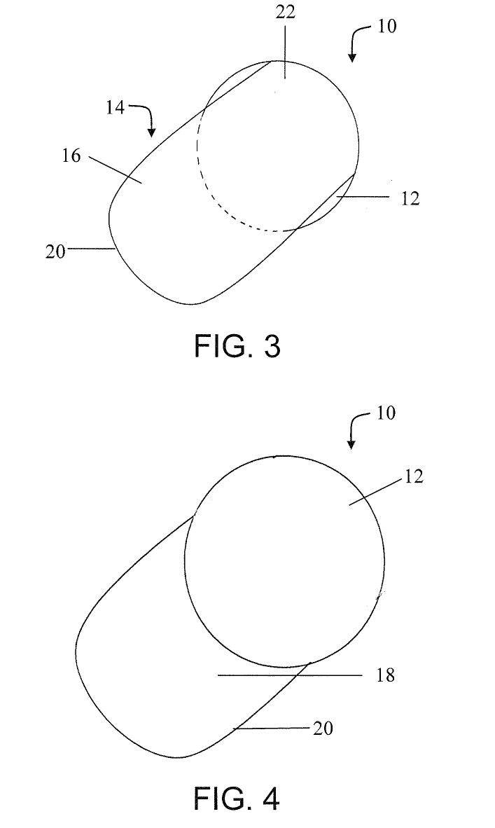

In one embodiment of the invention, the rigid element 14 is substantially flat and elongated. In another embodiment of the invention, the distal end 20 of the rigid element 14 is rounded as seen in FIGS. 1 and 2. In yet another embodiment of the invention, as seen in FIGS. 3 and 4, the distal end 20 of rigid element 14 is shaped substantially like a user's fingernail, that is, the distal end 20 has substantially rounded corner portions. The first surface 16 of the rigid element 14 may have serrations or grooves to aid in grasping the device 10. The rigid element 14 has a length adequate to be easily handled by a digit of a user on the first surface 16 and touches the surface of skin near the distal end 20. The rigid element 14 may be prepared from a material such as a metal or metal alloy, including those metals or metal alloys as used in dental or surgical equipment, or from a structural plastic material such as a thermoplastic or thermoset material. The material is safe for use in contact with the skin and strong enough so that it will not break when pressure is applied during normal use.

In another embodiment of the invention, the base member 12 may have a shape that is substantially spherical or ellipsoidal. In yet another embodiment of the invention, the base member 12 may be prepared from a non-porous, moldable material. An example of a non-porous, moldable material for base member 12 includes thermoplastic elastomers and polymers of ethylene and propylene, which includes polyethylene and polypropylene. In yet another embodiment of the invention, the base member 12 is made of a porous material, an adsorbent material or a porous and adsorbent material. In one embodiment, the porous and/or adsorbent materials include natural or synthetic sponges. The natural sponges are mostly marine, water dwelling, filter feeders found in oceans throughout the world, but can include cellulose wood fiber-based sponges. The synthetic sponges are prepared from foamed plastic polymers and include low-density polyether, which are known as non-absorbent sponges, polyvinyl alcohol-based sponges (PVA-based sponges), which are very dense, highly absorbent materials with no visible pores and polyester. The polyester sponges are also sub-divided into a variety of types including being reticulated (artificially broken-in) for ease of use and double-blown polyester, which have a high water retention ability, approaching or equaling PVA, but with visible pores and more flexibility of applications.

In another embodiment of the invention, the base member 12 includes a topical facial solution. The topical facial solution may include an anti-bacterial solution, a cleansing solution and mixtures thereof.

In one embodiment of the invention, the anti-bacterial solution includes a peroxide. In yet a further embodiment of the invention, the peroxide is benzoyl peroxide. In addition to its therapeutic effect as a keratolytic, which is a chemical that is capable of dissolving the sebum and keratin residing in the pores of the skin, benzoyl peroxide also prevents new lesions by killing the bacterium Propionibacterium acnes (P. acnes). In another embodiment of the invention, the anti-bacterial solution may include triclosan or chlorhexidine gluconate.

In yet another embodiment of the invention, the cleansing solution is a mixture of chemical agents designed to make the external layer of the skin, also known as the epidermis, as well as the pores of the epidermis, softer and more pliable. The cleansing solution also has the ability to loosen components of the facial blemish, including whiteheads and blackheads, prior to removal. The components loosened by the cleansing solution include dead skin cells, sebum, which is an oil secreted by the sebaceous gland within the skin, and dirt. In one embodiment, the cleansing solution includes water, iodine and Epsom salt.

The use of a peroxide in the anti-bacterial solution of the topical facial solution has the advantage of being a strong oxidizer which is essentially a mild bleach. However, this also has a tendency to routinely cause irritations such as dryness and redness of the skin to areas which the anti-bacterial solution has been applied. To overcome these irritations, the topical facial solution may include a moisturizer in the cleansing solution. In one embodiment, the cleansing solution includes naturally occurring skin lipids and sterols as well as artificial or natural oils, humectants, emollients, and lubricants.

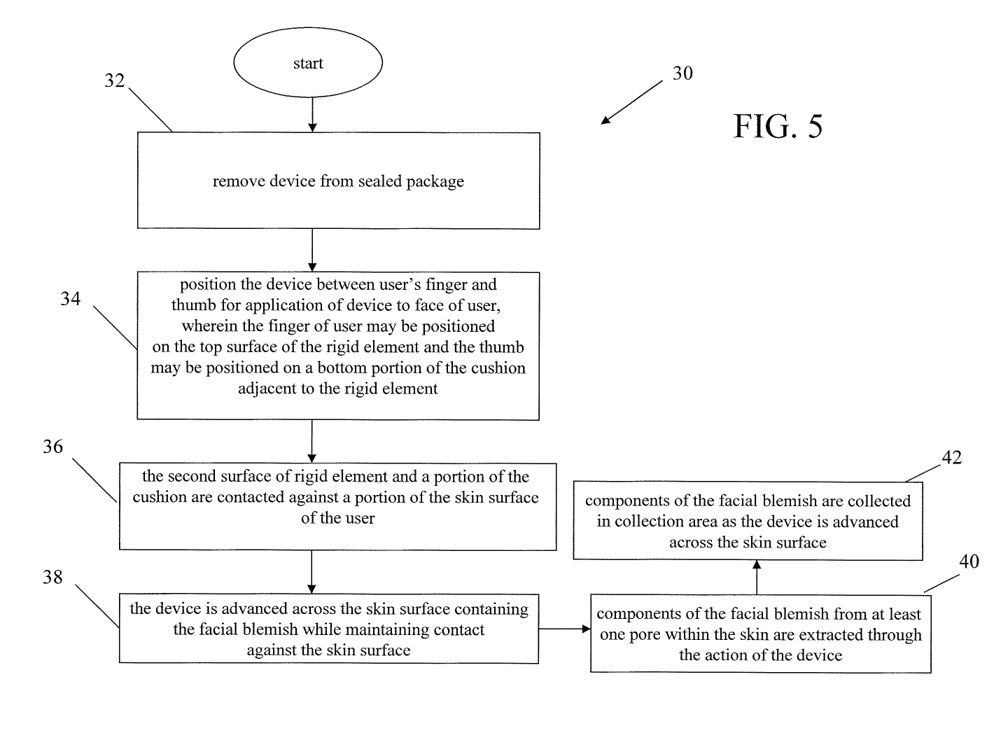

FIG. 5 illustrates a process diagram of an exemplary embodiment of a process for using device 10 for removing a facial blemish, such as a blackhead. Step 32 shows that the device 10 may be removed from a sealed package. Next, in step 34, the device 10 may be positioned between a user's finger, such as an index finger, and thumb for application to the face of the user. In particular, the finger of the user may be positioned on the first surface 16 of the distal end 20 of the rigid element 14 and the thumb may be positioned on a bottom portion of the base member 12 that is adjacent to the rigid element 14. Next, as described in step 36, the second surface 18 of the rigid element 14 and a portion of the base member 12 are contacted against a portion of the skin surface of the user. In step 38, the device 10 may be advanced across the skin surface containing the facial blemish while maintaining contact against the skin surface. Next, in step 40, components of the facial blemish from at least one pore within the skin may be extracted through the action of the device 10. Finally, as described in step 42, the components of the facial blemish may be collected in the collection area 24 as the device 10 is advanced across the skin surface of the user. After the components of the facial blemish have been collected, single-use device 10 may then be discarded.

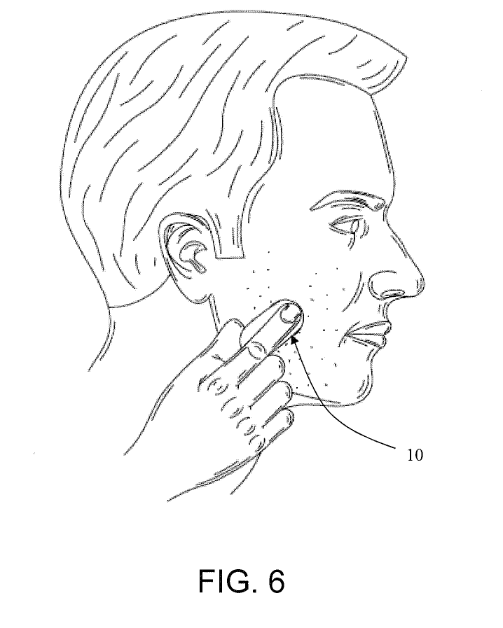

FIG. 6 illustrates a user holding and using device 10 on the skin surface of the face for removing a facial blemish, such as a blackhead.

In still yet another embodiment of the invention, device 10 is equipped with a securing means that is attached to first surface 16 of rigid element 14. For example, securing means may be a solid ring-shaped attachment, wherein the digit of a user is inserted into the ring-shaped attachment prior to use of removing a facial blemish with device 10. In another example, the securing means may be a plurality of hook and loop type fastening straps attached to first surface 16 of rigid element 14 or base member 12. In one embodiment, a first hook and loop type fastening strap is folded over the digit of a user as the digit rests on the first surface 16 of rigid element 14 and then a second hook and loop type fastening strap is folded onto the first hook and loop type fastening strap to secure the user's digit to device 10 prior to use of removing a facial blemish.

In yet another embodiment of the invention, device 10 is a multi-use device. In this embodiment, multi-use device 10 may be cleaned with soap, water and/or an alcohol, such as isopropyl alcohol, after the components of the facial blemish are collected. Device 10 may then be stored in an accessible location, such as a bathroom drawer for example, and be reused, as needed, at a future time.

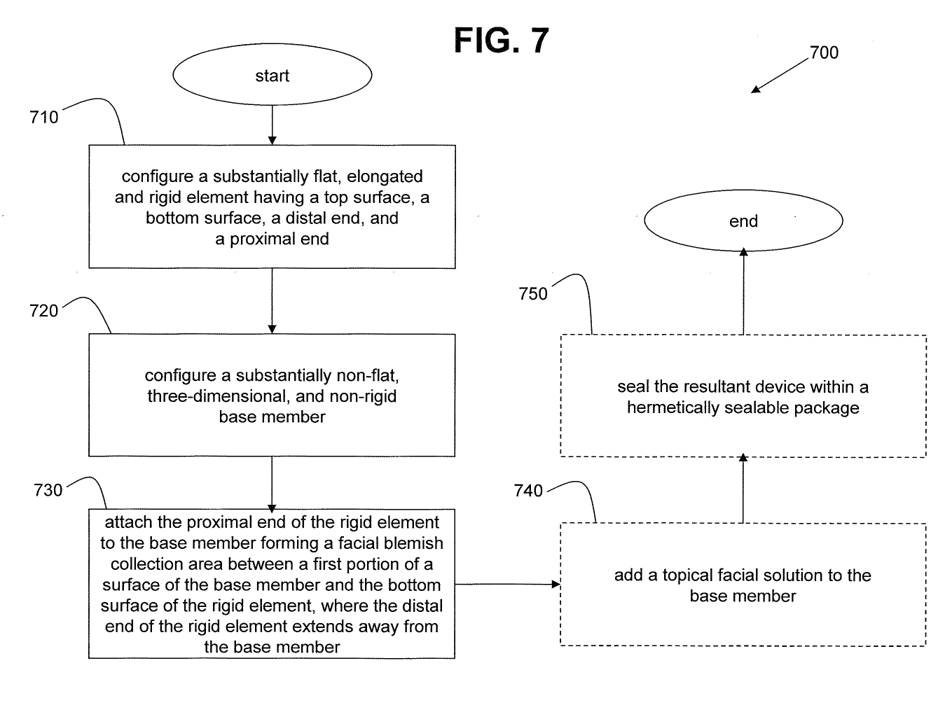

FIG. 7 illustrates an embodiment of a method 700 of making a device for removing a facial blemish. Again, a facial blemish may include whiteheads, blackheads, pimples, and acne, for example. In step 710, configure a substantially flat, elongated and rigid element having a top surface, a bottom surface, a distal end, and a proximal end. In step 720, configure a substantially non-flat, three-dimensional, and non-rigid base member. In step 730, attach the proximal end of the rigid element to the base member forming a facial blemish collection area between a first portion of a surface of the base member and the bottom surface of the rigid element where the distal end of the rigid element extends away from the base member.

The steps 710-730 of configuring and attaching are performed to result in a device that is capable of being gripped between a user's finger and thumb (e.g., as shown in FIG. 6), where the finger rests on the top surface of the rigid element and the thumb rests on a second portion of the surface of the base member. Furthermore, the steps 710-730 of configuring and attaching are performed to result in a device that is capable of being advanced across a face of the user when gripped (e.g., as shown in FIG. 6), where at least the distal end of the rigid element and the first portion of the surface of the base member make contact with the face of the user as the device is advanced. Such a configuration allows components of a facial blemish from at least one pore within a skin surface of the face to be extracted and collected into the facial blemish collection area as the device is advanced.

The rigid element and/or the base member may be configured via an injection molding process, for example. Alternatively, the rigid element and/or the base member may be configured via a cutting process, for example. The attaching step may be performed by snapping the proximal end of the rigid element into a receiving aperture of the base member, for example. As an alternative, the attaching step may be performed by adhering the proximal end of the rigid element to the base member using, for example, an adhesive.

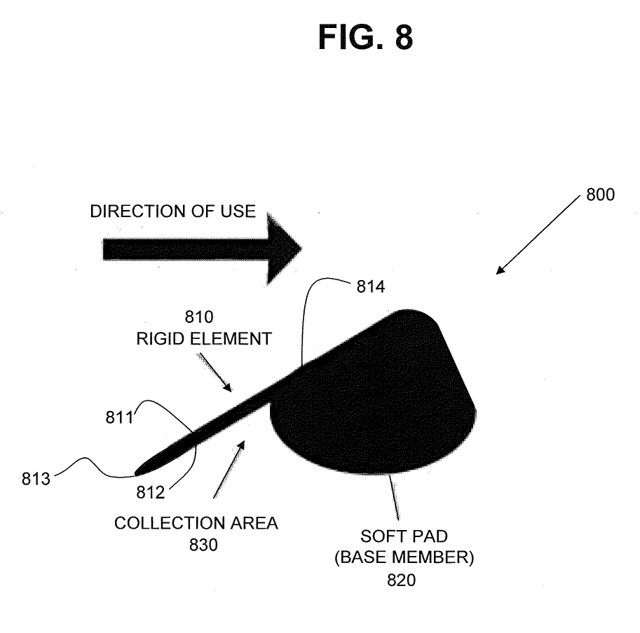

FIG. 8 illustrates a side view of yet another embodiment of a device 800, as made according to the method 700, for removing a facial blemish. The device 800 includes a substantially flat, elongated rigid element 810 (e.g., a facial scraping element) having a top surface 811, a bottom surface 812, a distal end 813, and a proximal end 814. The rigid element 810 may be prepared from a material such as a metal or metal alloy, including those metals or metal alloys as used in dental or surgical equipment, or from a structural plastic material such as a thermoplastic or thermoset material. The material is safe for use in contact with the skin and strong enough so that it will not break when pressure is applied during normal use. The device 800 also includes a substantially non-flat, three-dimensional, and non-rigid base member 820 (e.g., a pad member). The term “three-dimensional” as used herein with respect to the base member 820 means that the base member 820 is not flat and is not elongated as is the rigid element 810 but, instead, has dimensions (length, width, and height) that are substantially similar to each other (e.g., a sphere having a diameter D). The proximal end 814 of the rigid element 810 is attached to the base member 820 forming a facial blemish collection area 830 between a first portion of a surface of the base member 820 and the bottom surface 812 of the rigid element 810. The distal end 813 of the rigid element 810 extends away from the base member 820.

In accordance with certain embodiments of the present invention, the step 710 of configuring the rigid element 810 results in the distal end 813 being a narrow edge. Such a narrow edge facilitates removal of facial blemishes as the device 800 is advanced across the face of a user. In accordance with certain other embodiments of the present invention, the step 710 of configuring the rigid element 810 results in the distal end 813 being a coarse surface capable of scraping a facial blemish off of a facial surface of the user when advanced across the facial surface. For example, the distal end may be transformed via a cutting or shaving process to form a narrow edge. As another example, the distal end may be transformed by etching a surface at or near the distal end to form a coarse surface.

The base member 820 may be substantially spherical or ellipsoidal in shape and may be made of a non-porous material or a porous and/or an absorbent material. An example of a non-porous, moldable material for base member 820 includes thermoplastic elastomers and polymers of ethylene and propylene, which includes polyethylene and polypropylene. Porous and/or adsorbent materials may include natural or synthetic sponges, for example. The base member 820 may include a coarse surface capable of loosening a facial blemish on a facial surface of a user when advanced across the facial surface. Alternatively, the base member 820 may include a non-coarse (e.g., soft) surface and/or an absorbent surface. As an option, in step 740, the method 700 may further include adding a topical facial solution to the base member. The facial solution may include an anti-bacterial solution and/or a cleansing solution. As a further option, in step 750, the method 700 may further include sealing the resultant device 800 within a hermetically sealable package (not shown).

In accordance with certain embodiments of the present invention, the step 730 of attaching results in the rigid element 810 being fixedly attached to the base member 820. That is, the rigid element 810, once attached to the base member 820, is not meant to be de-tached from the base member 820. In accordance with certain other embodiments of the present invention, the rigid element 810 and the base member 820 are configured such that the rigid element 810 may be attached and subsequently de-tached from the base member 820 multiple times. Such embodiments of attaching and de-taching may include snap fitting and unsnapping, and slidably fitting and unslidably fitting, for example.

In summary, methods of making a device for removing a facial blemish are disclosed. A facial scraping element is configured to be substantially rigid and flat, and a distal end of the facial scraping element is transformed for contacting and advancing across a facial surface of a user. A pad member is configured to be substantially non-rigid and non-flat. The facial scraping element may be attached to the pad member to form a collection area between a surface of the pad member and a surface of the facial scraping element. The resultant device is capable of being gripped between a finger and thumb of a user and advanced across the face of a user to remove and collect facial blemishes.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of making a device for removing a facial blemish, the method comprising the steps of:
configuring a substantially flat, elongated and rigid element having a top surface, a bottom surface, a distal end, and a proximal end;
configuring a substantially non-flat, three-dimensional, and non-rigid base member; and
attaching said proximal end of said rigid element to said base member forming a facial blemish collection area between a first portion of a surface of said base member and said bottom surface of said rigid element, said distal end of said rigid element extending away from said base member,
wherein said steps of configuring and attaching result in a device that is capable of being gripped between a user's finger and thumb, where the finger rests on said top surface of said rigid element and the thumb rests on a second portion of said surface of said base member,
and wherein said steps of configuring and attaching result in a device that is capable of being advanced across a face of said user when gripped, where at least said distal end of said rigid element and said first portion of said surface of said base member make contact with said face of said user as said device is advanced, and where components of a facial blemish from at least one pore within a skin surface of said face are extracted and collected into said facial blemish collection area as said device is advanced.

2. The method of claim 1 wherein said step of configuring said rigid element results in said distal end of said rigid element being a narrow edge.

3. The method of claim 1 wherein said base member has a shape selected from the group consisting of a substantially spherical shape and an ellipsoidal shape.

4. The method of claim 1 wherein said base member is comprised of a porous material.

5. The method of claim 1 wherein the base member is comprised of an absorbent material.

6. The method of claim 1 further comprising adding a topical facial solution to said base member.

7. The method of claim 6 wherein said facial solution includes an anti-bacterial solution.

8. The method of claim 6 wherein the facial solution includes a cleansing solution.

9. The method of claim 1 wherein said step of attaching results in said rigid element being fixedly attached to said base member.

10. The method of claim 1 wherein said rigid element is detachable from said base member.

11. The method of claim 1 further comprising sealing said resultant device within a hermetically sealable package.

12. The method of claim 1 wherein said facial blemish is selected from the group consisting of whiteheads, blackheads, pimples and acne.

13. The method of claim 1 wherein said facial blemish is a blackhead.

14. A method of making a device for removing a facial blemish, the method comprising the steps of:
configuring a substantially flat, elongated and rigid element having a top surface, a bottom surface, a distal end, and a proximal end; and
configuring a substantially non-flat, three-dimensional, and non-rigid base member,
wherein said steps of configuring allow said rigid element to be attached to said base member to form a facial blemish collection area between a first portion of a surface of said base member and said bottom surface of said rigid element where said distal end of said rigid element extends away from said base member,
and wherein, when attached, said rigid element and said base member form a device that is capable of being gripped between a user's finger and thumb, where the finger rests on said top surface of said rigid element and the thumb rests on a second portion of said surface of said base member,
and wherein, when attached, said rigid element and said base member form a device that is capable of being advanced across a face of said user when gripped, where at least said distal end of said rigid element and said first portion of said surface of said base member make contact with said face of said user as said device is advanced, and where components of a facial blemish from at least one pore within a skin surface of said face are extracted and collected into said facial blemish collection area as said device is advanced.

15. The method of claim 14 wherein said step of configuring said rigid element results in said distal end of said rigid element being a narrow edge.

16. The method of claim 14 wherein said base member has a shape selected from the group consisting of a substantially spherical shape and an ellipsoidal shape.

17. The method of claim 14 further comprising fixedly attaching said rigid element to said base member.

18. The method of claim 14 further comprising removably attaching said rigid element to said base member.

19. The method of claim 14 further comprising adding a topical facial solution to said base member.

20. The method of claim 14 further comprising sealing said rigid element and said base member within a hermetically sealable package.

21. A method of making a device for removing a facial blemish, the method comprising the steps of:
configuring a facial scraping element to be substantially rigid and flat, and having an upper surface and a lower surface, and further having a proximal end and a distal end;
transforming said distal end of said facial scraping element for contacting and advancing across a facial surface of a user;
configuring a pad member to be substantially non-rigid and non-flat; and
attaching said proximal end of said facial scraping element to said pad member forming a collection area between a surface of said pad member and said lower surface of said facial scraping element, wherein said distal end of said facial scraping element extends away from said pad member.

22. The method of claim 21 wherein said step of transforming said distal end includes forming said distal end into a narrow edge capable of scraping a facial blemish off of a facial surface of said user when advanced across said facial surface.

23. The method of claim 21 wherein said step of transforming said distal end includes forming said distal end into a coarse surface capable of scraping a facial blemish off of a facial surface of said user when advanced across said facial surface.

24. The method of claim 21 wherein said pad member includes a coarse surface capable of loosening a facial blemish on a facial surface of a user when advanced across said facial surface.

25. The method of claim 21 wherein said pad member includes a non-coarse and absorbent surface.
